(19) United States
(12) Patent Application Publication
(10) Pub. No.: US 2024/0141948 A1
(43) Pub. Date: May 2, 2024

(54) CONNECTOR FOR TWO COMPONENTS

(71) Applicant: Knapp Holding GmbH, Euratsfeld (AT)

(72) Inventor: Friedrich KNAPP, Bad Kreuzen (AT)

(21) Appl. No.: 18/555,872

(22) PCT Filed: Mar. 24, 2022
(86) PCT No.: PCT/EP2022/057785

§ 371 Date: Oct. 18, 2023

(30) Foreign Application Priority Data
Apr. 23, 2021 (EP) 21170061.2

(51) Int. Cl. F16B 39/04; F16B 35/00

(52) U.S. Cl. CPC F16B 39/04; F16B 35/005; F16B 25/0015

(57) ABSTRACT

The present subject matter relates to a connector for two components of which the first component has a first bore extending from a bearing surface and the second component has an opening extending from a bearing surface and has a second bore traversing the opening. The connector comprises a retaining bolt with a threaded portion for screwing into or behind the first bore and an unthreaded portion for inserting into the opening. The unthreaded portion is traversed by a transverse bore, and a tensioning bolt with a conical end, which, when the retaining bolt is screwed into or behind the first bore and inserted into the opening, can be inserted into the second bore and into the transverse bore, to align them relative to one another and thus tension the bearing surfaces against one another.

### CROSS-REFERENCE TO RELATED APPLICATION/S

This application is a National Phase application of International Application No. PCT/EP2022/057785 filed Mar. 24, 2022 which claims priority to the European Patent Application No. 21 170 061.2 filed Apr. 23, 2021, the disclosures of which are incorporated herein by reference.

### TECHNICAL FIELD

The present disclosed subject matter relates to a connector for two components, in particular wooden components, of which the first component has a first bore extending from a bearing surface for the second component and the second component has an opening which extends from a bearing surface for the first component and corresponds with the first bore and has a second bore which transverses the opening.

The components can be made of wood, stone, brick, concrete, reinforced concrete, metal etc. and in particular of a different material. For example, the second component bears on the first component; thus one of the two components can be a post or stand and the other can be a beam, a joist or the like.

### BACKGROUND ART

A connector for such components is known from U.S. Pat. No. 5,741,083; this connector comprises a connecting tube which is transversed by an elongated hole close to each of its two ends. The connecting tube is inserted into the first bore of the first component and into the corresponding opening of the second component. In the region of the elongated holes, also each of the two components is also transversed by a second bore so that when the two components are in contact on their bearing surfaces, an expansion bolt can be inserted into each of the two second bores as far as the respective elongated hole in the connecting tube. Each expansion bolt has an axial tensioning screw and two opposite directed conical pieces and is surrounded by two cylindrical half shells. After insertion each expansion bolt is aligned in the elongated hole; then the half shells are forced on radially by drawing together the conical pieces by means of the tensioning screw. The expansion bolts thereby fill the elongated holes and at the same time thereby tension the bearing surfaces of the two components against one another.

The disadvantage of this is not only that the two bolts have a complex, multipart structure and both components are traversed fully by the said second bores in order to make the expansion bolts accessible for aligning and forcing on respectively at both ends, but in particular the assembly is difficult during which the bolts should not be twisted.

U.S. Pat. No. 5,074,702 describes a connector, in which a retaining bolt is screwed behind a first component so that it can move with play and its head is inserted into an opening in a second component. The head has a conical transverse bore in which a corresponding conical tip of a tensioning screw screwed into the second component engages. In this way, on the one hand the two components are drawn against one another and on the other hand the retaining bolt is pressed against the wall of the opening in the second component opposite the tensioning screw in order to fix it, which leads on the whole to an asymmetrical distribution of tension in the retaining bolt and to shearing stress on the tip of the tensioning screw. The tensioning screw has to be secured against loosening due to the conicity of its tip and the transverse bore.

### BRIEF SUMMARY

The aim of the disclosed subject matter is to create a connector for two components, which has a particularly simple structure and is particularly uncomplicated to handle when connecting the two components yet still produces a permanent and secure connection between the components.

This aim is achieved by a connector for two components, in particular wooden components, of which the first component has a first bore extending from a bearing surface for the second component and the second component has an opening which extends from a bearing surface for the first component and corresponds with the first bore and has a second bore which transverses the opening, which connector has a retaining bolt with a threaded portion for screwing into or behind the first bore and an unthreaded portion for inserting into the opening, wherein the unthreaded portion is traversed by a cylindrical transverse bore and has a cylindrical tensioning bolt with a conical end, which, when the retaining bolt assumes its postion screwed in or behind the first bore and inserted into the opening, can be inserted into the second bore and into the transverse bore, in order to align them with one another and thus tension the bearing surfaces against one another.

The threaded portion of the retaining bolt eliminates the need for a second bore on the first component that transversees the first bore and thereby prevents the associated weakening of the—often load-bearing—first component. Here the retaining bolt can be already screwed in particular in the factory—into or behind the first bore and thereby anchored to the first component and thus can also be used to manipulate the first component. The retaining bolt can be anchored at a suitable depth onto the first component so that the tensioning bolt, which has a particularly simple structure, with its conical end aligns the second bore and the transverse bore on insertion into the transverse bore and tensions the two components against one another on their respective bearing surfaces. In this way the connector provides a permanently secure and tight connection by tensioning the two components and is no longer loosened by the frictional and clamping forces of the tensioning bolt on the retaining bolt after the two components have been connected. To form the connection the tensioning bolt does not need to be accessible from both sides so that the second bore may be a blind bore, which reduces any weakening of the second component.

It is particularly advantageous if the tensioning bolt has an unthreaded portion surrounding the conical end and a threaded portion with a greater nominal diameter than the unthreaded portion and is configured on its end face facing away from the conical end for the application of a screwdriver. In this case a screwdriver is understood to be any tool that can turn a threaded bolt (or a screw) around its longitudinal axis, i.e. in addition to conventional flat-tip, cross-head, or other screwdrivers also e.g. an Allen key or the like. The threaded portion simplifies the insertion of the tensioning bolt into the said second bore of the second component and in particular into the transverse bore of the retaining bolt, as the rotational movement depending on the thread pitch of the threaded portion causes either a rapid insertion or a slow, even insertion thereby generating a high force in insertion direction. In addition, the threaded portion allows the connection between the two components to be loosened later by simply unscrewing the tensioning bolt, i.e. in particular without additional accessibility of the tensioning bolt at its conical end and thus also without a second bore that fully traverses the second component.

The conical end of the tensioning bolt is either a short tip, or extends over a greater part of the unthreaded portionion; in an advantageous embodiment, the conical end of the tensioning bolt extends over the whole unthreaded portion. In this way a smaller cone opening angle is possible and thus an easier insertion of the tensioning bolt into the transverse bore can be achieved.

It is particularly advantageous if the conical end of the tensioning bolt has a cone opening angle of between 20° and 120°, optionally between 40° and 60°. Depending on the material and size of the components a tensioning bolt can be used which can be inserted into the transverse bore either particularly rapidly (larger cone opening angle) or with less force (smaller cone opening angle); in each case this produces a secure connection between the two components.

The retaining bolt can be configured to be solid, but it is advantageous if at least one end-face region of the unthreaded portion of the retaining bolt is tubular. Additional weight is saved if the retaining bolt is at least partly or fully tubular.

It is particularly easy to screw the retaining bolt into the first bore and thus anchor it onto and align it with the first component if the unthreaded portion of the retaining bolt has an end-face notch for the application of an assembly tool.

It is also advantageous if the retaining bolt has a further unthreaded portion on the side of the threaded portion facing away from the said unthreaded portion with a diameter corresponding to or smaller than the core diameter of the threaded portion. The further unthreaded portion acts as a guide in the first bore when the retaining bolt is screwed in and thus simplifies the anchoring of the retaining bolt to the first component.

In one advantageous embodiment the threaded portion of the retaining bolt is configured for screwing with a screw nut. This allows the connector to be used in a wide range of applications. In particular, the threaded portion can be configured as a metric thread, wherein the retaining bolt is screwed behind the first bore e.g. to a corresponding screw nut, and the first bore is mostly unthreaded. Depending on the material of the first component the first bore can be provided alternatively with a corresponding internal thread in the manner of a screw nut for screwing the retaining bolt.

It is particularly advantageous if the threaded portion of the retaining bolt has one or more millings distributed around the circumference and extending in the longitudinal direction of the retaining bolt, which optionally extend to the core diameter of the threaded portion. The threaded portion of the retaining bolt thus cuts an internal thread into the first bore when it is screwed together.

Furthermore, it is advantageous if the retaining bolt has a circumferential notch in an area of said unthreaded portion adjoining the threaded portion. In this way, when the retaining bolt is screwed into or behind the first bore the depth of the screwed connection can be easily identified using the notch as a measuring mark, which further simplifies the handling of the connector.

### BRIEF DESCRIPTION OF THE DRAWINGS/FIGURES

The disclosed subject matter is explained in more detail in the following with reference to embodiments illustrated in the accompanying drawings. In the drawings:

FIG. 1 shows a connector according to the disclosed subject matter for two components in a partly transparent perspective view obliquely from above;

FIGS. 2a and 2b show the connector of FIG. 1 in an open position (FIG. 2a) and a connected position (FIG. 2b), both in a side view;

FIG. 3 shows the two components connected to the connector of FIG. 1 in a partly transparent perspective view obliquely from above;

FIG. 4 shows a retaining bolt of the connector of FIG. 1 in a perspective view obliquely from above;

FIGS. 5a and 5b show respectively a variant of a threaded portion of the retaining bolt or a tensioning bolt of the connector of FIG. 1 with one (FIG. 5a) or two millings (FIG. 5b), each in perspective view obliquely from above; and

FIGS. 6a and 6b show a transport attachment for the retaining bolt of FIG. 4 in a non-assembled position (FIG. 6a) and an assembled position (FIG. 6b) mounted on the retaining bolt, each in a perspective view obliquely from above.

### DETAILED DESCRIPTION

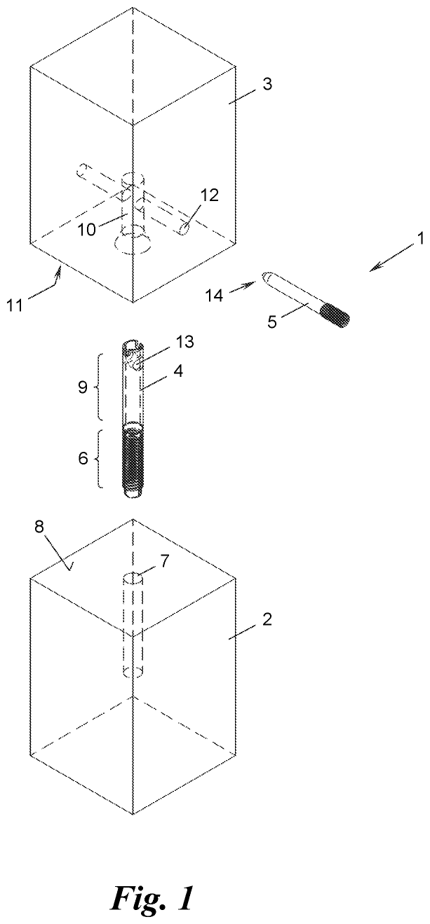

FIG. 1 shows a connector 1 for connecting two components 2, 3. The components 2, 3 can be of any type, e.g. a post, a stand, a beam, a joist, two furniture parts etc. and can be made of any material, e.g. wood, plastic, stone, brick, concrete, reinforced concrete, metal etc., and also of different materials. The connector 1 is particularly suitable for connecting wooden components 2, 3, for example in furniture construction or industrial timber construction. Depending on the strength requirements, the connector 1 can be made of different materials, e.g. wood, plastic, metal or combinations thereof.

The connector has a retaining bolt 4 and a tensioning bolt 5. The retaining bolt 4 has a threaded portion 6 in its axial direction, which in the example shown can be screwed into a first bore 7 of a first component 2 of the two components 2, 3. The first bore 7 extends from a bearing surface 8 for the second component 3, and in the shown example is perpendicular to the bearing surface 8; the first bore 7 could alternatively be bored obliquely from the bearing surface 8 into the first component 2. In the example of FIG. 1 the first bore 7 is a blind bore. Alternatively, the first bore 7 may pass completely through the first component 2 and the retaining bolt 4 may optionally be screwed behind the first bore, e.g. with a screw nut (not shown). The threaded portion 6 of the retaining bolt 4 and the screw nut can have e.g. metric threads or other corresponding threads for this purpose. If the threaded portion 6 is screwed directly into the first bore 7, as in the example of FIG. 1, it optionally has the threaded form of a wood screw for example if the first component 2 is made of wood or the like, etc.

Adjoining the threaded portion 6 in axial direction, the retaining bolt 4 also has an unthreaded portion 9 which can be inserted into an opening 10 on the second component 3 to connect the two components 2, 3. The opening 10 extends from a bearing surface 11 of the second component 3 for bearing on the first component 2 and corresponds with the first bore 7 of the first component 2, in order to receive the unthreaded portion 9 of the retaining bolt 4; i.e. the opening 10 can be arranged in extension of the first bore 7 when the bearing surfaces 8, 11 of the two components 2, 3 are in contact with one another. In the example shown the opening 10 is also a bore, i.e. it has a circular cross-section; alternatively however, it could also have a different cross-section which allows the insertion of the retaining bolt 4, in particular the opening 10 can be slot-shaped for example. The opening 10 is transversed by a second bore 12.

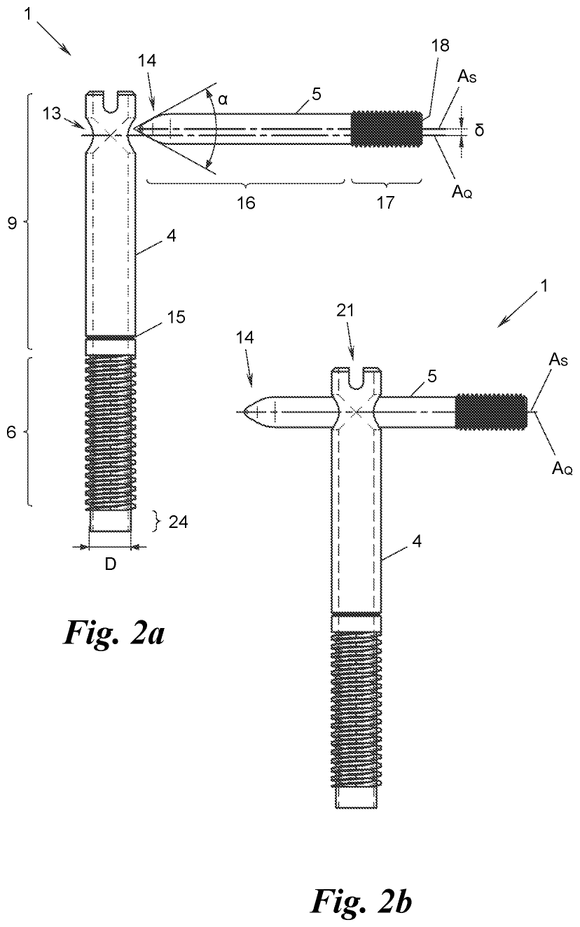

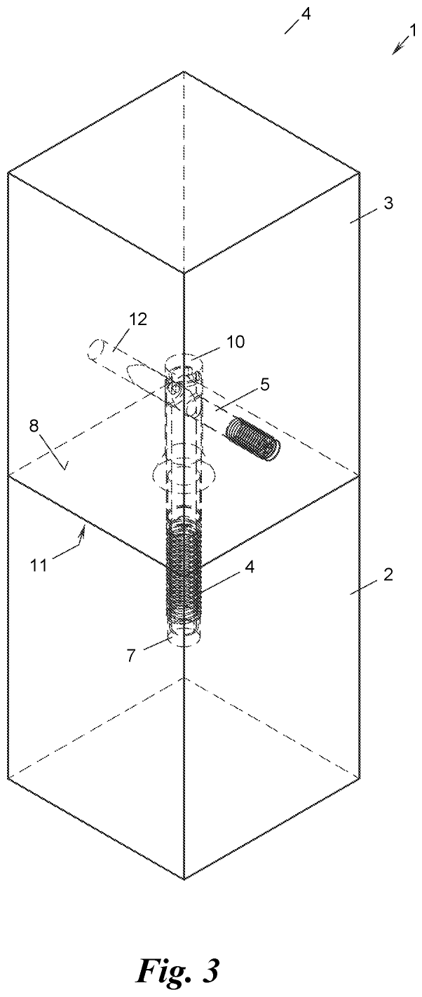

In the following the connection of the two components 2, 3 by means of the retaining bolt 4 and the tensioning bolt 5 of the connector 1 is explained with reference to FIGS. 2a, 2b and 3, for which purpose the retaining bolt 4 has a transverse bore 13 for inserting the tensioning bolt 5 and the tensioning bolt 5 has a conical end 14.

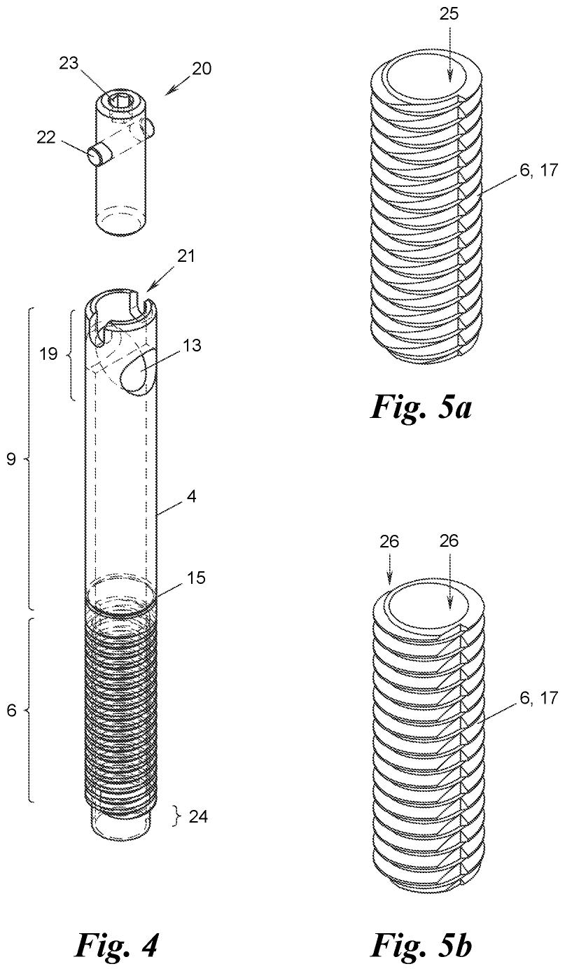

Firstly, the threaded portion 6 of the retaining bolt 4 is screwed to the first component 2 in or behind the first bore 7, e.g. up to the end of the threaded portion 6 or up to an optional circumferential indentation 15 in a region of its unthreaded portion 9 adjoining the threaded portion 6 of the retaining bolt 4. The unthreaded portion 9 of the retaining bolt 4 is then inserted into the opening 10 of the second component 3 and the second component 3 is fitted on top until the two bearing surfaces 8, 11 bear on one another. The transverse bore 13 of the retaining bolt 4 is thereby aligned with respect to the second bore 12, i.e. either before the insertion of the unthreaded portion 9 of the retaining bolt 4 into the opening 10 or after the insertion, if the retaining bolt 4 remains accessible, e.g. because its threaded portion 6 is screwed behind the first bore 7 or because, as explained in more detail below with reference to FIG. 4, the opening 10 passes fully through the second component 3. On the one hand the transverse bore 13 is aligned in axial direction of the second bore 12 of the second component 3; on the other hand the unthreaded portion 9 of the retaining bolt 4 after it has been screwed should only protrude from the bearing surface 8 of the first component 2 so far that an offset δ remains between an axis A_{Q} of the transverse bore of the retaining bolt 4 and a longitudinal axis A_{S} of the tensioning bolt 5, when the tensioning bolt 5 is initially only inserted into the second bore 12 with its conical end 14 (FIG. 2a), e.g. is pressed in or driven in with a hammer if the tensioning bolt 13 is unthreaded. The offset δ is selected e.g. according to the material of the first and second component 2, 3, or of the retaining bolt and the tensioning bolt 4, 5 and/or a cone opening angle α of the conical end 14 of the tensioning bolt 5.

If the tensioning bolt 5 is inserted further into the second bore 12 in this position of the retaining bolt 4, its conical end 14 firstly enters the transverse bore 13 of the retaining bolt 4, then the tensioning bolt 5 aligns the second bore 12 and the transverse bore 13 with one another, i.e. the tensioning bolt 13 draws the retaining bolt 4 deeper into the opening 10 of the second component 3 due to its conical end 14 so that the offset δ is compensated (FIG. 2b), and thus tensions the bearing surfaces 8, 11 of the two components 2, 3 against one another (FIG. 3).

In the shown example the tensioning bolt 13 has an unthreaded portion 16, which also comprises the conical end 14, and an optional threaded portion 17 adjoining it in its axial direction. The threaded portion 17 has a larger nominal diameter than the unthreaded portion 16, i.e. its thread projects radially beyond the unthreaded portion 16. Furthermore, the tensioning bolt 13 has an internal hexagon, a cross-head, a slot or the like on its end face 18 facing away from the conical end 14 for the engagement of a screwdriver. For inserting its unthreaded portion 16 into the transverse bore 13 of the retaining bolt 4 the tensioning bolt 13 can thus be screwed into the second bore 12 and if necessary unscrewed from it again later.

The conical end 14 of the tensioning bolt 5 may extend over part of the unthreaded portion 16 of the tensioning bolt 5 or over its entire unthreaded portion 16. The cone opening angle α is for example between 20° and 120°, in particular between 40° and 60°; alternatively the cone opening angle α may be larger or in particular smaller. It is understood that the tip of the conical end 14 may be blunted, as shown.

As illustrated by a dashed line in the example of FIG. 4 the retaining bolt 4 is optionally tubular. Alternatively, the retaining bolt 4 is solid or only tubular in some sections, e.g. in an end-face region 19 of the unthreaded portion 9 of the retaining bolt 4, in order to be able to at least partly receive an optional assembly tool 20. For this purpose, the unthreaded portion 9 of the retaining bolt 4 also has an end-face notch 21, with which a transverse pin 22 of the assembly tool 20 engages in its applied state. The assembly tool 20 also has an internal hexagon 23 for the engagement of a corresponding key for screwing the retaining bolt 4 or its threaded portion 6 into or behind the first bore 7 of the first component 2. It is understood that the end-face notch 21 can also be used alternatively for engaging a flat-tip screwdriver, a rodlike turning handle or the like for screwing, i.e. even if the retaining bolt 4 is solid. If the opening 10 passes fully through the second component 3, the end-face notch 21 is also accessible even after the unthreaded portion 9 of the retaining bolt 4 has been inserted into the opening 10, so that its transverse bore 10 can be aligned as described.

In the example shown the retaining bolt 4 has an optional further unthreaded portion 24 on its side of the threaded portion 6 facing away from the unthreaded portion 9. The further unthreaded portion 24 has a diameter D, which is equal to or smaller than the core diameter—i.e. the smallest diameter of the thread geometry—of the threaded portion 6 of the retaining bolt 4.

FIGS. 5a and 5b show optional embodiment variants of the threaded portions 6 and 17 of the retaining bolt 4 and the tensioning bolt 5 (here: the threaded portion 6 of the retaining bolt 4). In the example of FIG. 5a, the threaded portion 6 has a milling 25 extending in the longitudinal direction of the retaining bolt 4. The milling 25 extends optionally to the core diameter of the threaded portion 6 and gradually tapers off in circumferential direction. In the example of FIG. 5b the threaded portion 6 has two millings 26 distributed around the circumference, which also extend in the longitudinal direction of the retaining bolt 4 or tensioning bolt 5 and optionally extend up to the core diameter of the threaded portion 6, 17; however, the millings 26 in the example of FIG. 5b have a triangular form, i.e. are not tapering off.

It is understood that alternatively more than two millings 25, 26 can be distributed over the circumference of the respective threaded portion 6, 17, the millings 25, 26 may not extend radially as far as the core diameter of the respective threaded portion 6, 17 and/or in axial direction only over part of the respective threaded portion 6, 17 or may be directed obliquely to the longitudinal direction of the retaining bolt or tensioning bolt 4, 5.

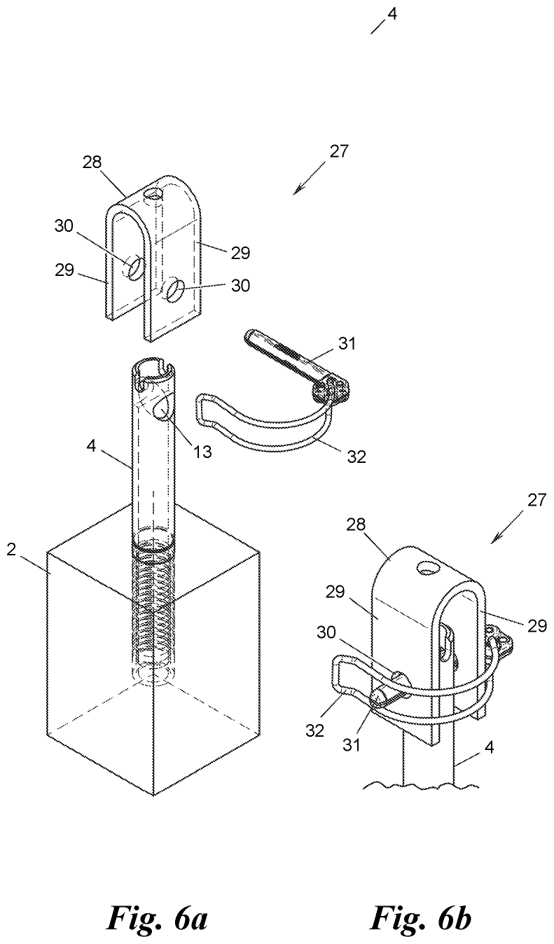

According to FIGS. 6a and 6b the retaining bolt 4 can be provided with a transport attachment 27, in particular after screwing its threaded portion 6 into or behind the first bore 7 of the first component 2. The transport attachment 27 has in the shown example an essentially U-shaped lug 28, the legs 29 of which are each traversed by a receiving bore 30 for a pin 31. The pin 31 is used to anchor the lug 28 to the transverse bore 13 of the retaining bolt 4 and secured to an optional securing clip 32, so that the retaining bolt 4 and—after screwing—the first component 2 can be easily transported or manipulated by the lug 28 (FIG. 6b).

The disclosed subject matter is not limited to the embodiments shown, but comprises all variants, modifications and combinations thereof which fall within the scope of the appended claims.

1. A connector for two components, of which the first component has a first bore extending from a first bearing surface for the second component and the second component has an opening which extends from a second bearing surface for the first component and corresponds with the first bore and has a second bore transversing the opening, comprising:
a retaining bolt with a threaded portion for screwing into or behind the first bore and an unthreaded portion for inserting into the opening, wherein the unthreaded portion is traversed by a cylindrical transverse bore; and
a cylindrical tensioning bolt with a conical end, which, when the retaining bolt is screwed into or behind the first bore and inserted into the opening, can be inserted into the second bore and into the transverse bore in order to align the second bore and the transverse bore relative to one another and thus tension the first and second bearing surfaces against one another.

2. The connector according to claim 1, wherein the tensioning bolt has an unthreaded portion comprising the conical end and a threaded portion with a larger nominal diameter than the unthreaded portion and is configured for applying a screwdriver on an end face facing away from the conical end.

3. The connector according to claim 2, wherein the conical end of the tensioning bolt extends over the entire unthreaded portion.

4. The connector according to claim 1, wherein the conical end of the tensioning bolt has a cone opening angle of between 20° and 120°.

5. The connector according to claim 1, wherein at least one end-face region of the unthreaded portion of the retaining bolt is tubular.

6. The connector according to claim 1, wherein the unthreaded portion of the retaining bolt has an end-face notch for applying an assembly tool.

7. The connector according to claim 1, wherein the retaining bolt has on a side of the threaded portion facing away from said unthreaded portion a further unthreaded portion with a diameter corresponding to or smaller than a core diameter of the threaded portion.

8. The connector according to claim 1, wherein the threaded portion of the retaining bolt is configured to be screwed to a screw nut.

9. The connector according to claim 1, wherein the threaded portion of the retaining bolt has one or more millings distributed in circumference direction and running in longitudinal direction of the retaining bolt.

10. The connector according to claim 1, wherein the retaining bolt has a circumferential indentation in a region of said unthreaded portion adjoining the threaded portion.

11. The connector according to claim 4, wherein the cone opening angle is between 40° and 60°.

12. The connector according to claim 9, wherein the one or more millings extend up to a core diameter of the threaded portion.
